(19) United States
(12) Patent Application Publication
(10) Pub. No.: US 2016/0360457 A1
(43) Pub. Date: Dec. 8, 2016

(54) FAST RETURN BASED ON FREQUENCIES RANKED ACCORDING TO SUSPENDED APPLICATION AND FREQUENCY CHARACTERISTICS

(71) Applicant: QUALCOMM Incorporated, San Diego, CA (US)

(72) Inventors: Ming YANG, San Diego, CA (US); Tom CHIN, San Diego, CA (US); Shaohong QU, San Diego, CA (US)

(21) Appl. No.: 14/732,466

(22) Filed: Jun. 5, 2015

(51) Int. Cl. H04W 36/14

(52) U.S. Cl. CPC H04W 36/14; H04W 36/36

(57) ABSTRACT

A user equipment (UE) periodically suspends communications on a first radio access technology (RAT) to redirect another communication or initiate the other communication on a second RAT. In one instance, the UE suspends an application running on the first RAT before switching to the second RAT. Prior to returning from the second RAT to the first RAT, the UE ranks frequencies of the first RAT in an acquisition history based on a type of a suspended application in the first RAT, and characteristics of each frequency in the acquisition history. The UE then search one or more frequencies in the acquisition history in accordance with the ranking.

### BACKGROUND

Field

Aspects of the present disclosure relate generally to wireless communication systems, and more particularly, to performing fast return to a first radio access technology (RAT) according to frequencies of the first RAT that are ranked based on a suspended application on the first RAT and characteristics of the frequencies.

Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is long term evolution (LTE). LTE is a set of enhancements to the universal mobile telecommunications system (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

According to one aspect of the present disclosure, a method of wireless communication includes suspending an application in a first radio access technology (RAT) before switching to a second RAT. The method also includes ranking frequencies of the first RAT, prior to returning from the second RAT to the first RAT, in an acquisition history based on a type of a suspended application in the first RAT, and characteristics of each frequency in the acquisition history. The method also includes searching at least one frequency in the acquisition history in accordance with the ranking.

According to another aspect of the present disclosure, an apparatus for wireless communication includes means for suspending an application in a first radio access technology (RAT) before switching to a second RAT. The apparatus may also include means for ranking frequencies of the first RAT, prior to returning from the second RAT to the first RAT, in an acquisition history based on a type of a suspended application in the first RAT, and characteristics of each frequency in the acquisition history. The apparatus may also include means for searching at least one frequency in the acquisition history in accordance with the ranking.

Another aspect discloses an apparatus for wireless communication and includes a memory and at least one processor coupled to the memory. The processor(s) is configured to suspend an application in a first radio access technology (RAT) before switching to a second RAT. The processor(s) is also configured to rank frequencies of the first RAT, prior to returning from the second RAT to the first RAT, in an acquisition history based on a type of a suspended application in the first RAT, and characteristics of each frequency in the acquisition history. The processor(s) is also configured to search at least one frequency in the acquisition history in accordance with the ranking.

Yet another aspect discloses a computer program product for wireless communications in a wireless network having a non-transitory computer-readable medium. The computer-readable medium has non-transitory program code recorded thereon which, when executed by the processor(s), causes the processor(s) to suspend an application in a first radio access technology (RAT) before switching to a second RAT. The program code also causes the processor(s) to rank frequencies of the first RAT, prior to returning from the second RAT to the first RAT, in an acquisition history based on a type of a suspended application in the first RAT, and characteristics of each frequency in the acquisition history. The program code also causes the processor(s) to search at least one frequency in the acquisition history in accordance with the ranking.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a diagram illustrating an example of a network architecture.

FIG. 2 is a diagram illustrating an example of a downlink frame structure in LTE.

FIG. 3 is a diagram illustrating an example of an uplink frame structure in LTE.

FIG. 4 is a block diagram conceptually illustrating an example of a telecommunications system.

FIG. 5 is a block diagram conceptually illustrating an example of a frame structure in a telecommunications system.

FIG. 6 is a block diagram illustrating an example of a global system for mobile communications (GSM) frame structure.

FIG. 7 is a block diagram conceptually illustrating an example of a base station in communication with a user equipment (UE) in a telecommunications system.

FIG. 8 is a diagram illustrating network coverage areas according to aspects of the present disclosure.

FIG. 9 shows a flow diagram conceptually illustrating an example process for fast return to a desirable frequency after redirection according to one aspect of the present disclosure.

FIG. 10 is a flow diagram illustrating a method for fast return according to one aspect of the present disclosure.

FIG. 11 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

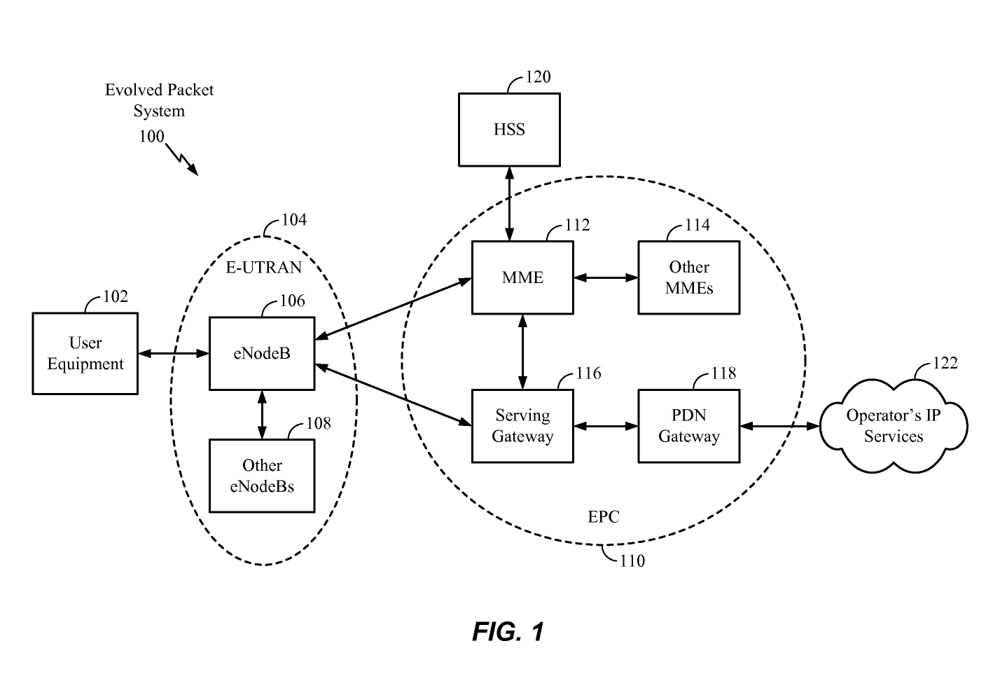

FIG. 1 is a diagram illustrating an LTE network architecture 100. The LTE network architecture 100 may be referred to as an evolved packet system (EPS) 100. The EPS 100 may include one or more user equipment (UE) 102, an evolved UMTS terrestrial radio access network (E-UTRAN) 104, an evolved packet core (EPC) 110, a home subscriber server (HSS) 120, and an operator's IP services 122. The EPS can interconnect with other access networks, but for simplicity those entities/interfaces are not shown. As shown, the EPS 100 provides packet-switched services, however, as those skilled in the art will readily appreciate, the various concepts presented throughout this disclosure may be extended to networks providing circuit-switched services.

The E-UTRAN 104 includes an evolved Node B (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an 51 interface. The EPC 110 includes a mobility management entity (MME) 112, other MMEs 114, a serving gateway 116, and a packet data network (PDN) gateway 118. The MME 112 is the control node that processes the signaling between the UE 102 and the EPC 110. Generally, the MME 112 provides bearer and connection management. All user IP packets are transferred through the serving gateway 116, which itself is connected to the PDN gateway 118. The PDN gateway 118 provides UE IP address allocation as well as other functions. The PDN gateway 118 is connected to the operator's IP services 122. The operator's IP services 122 may include the Internet, the Intranet, an IP multimedia subsystem (IMS), and a PS streaming service (PSS).

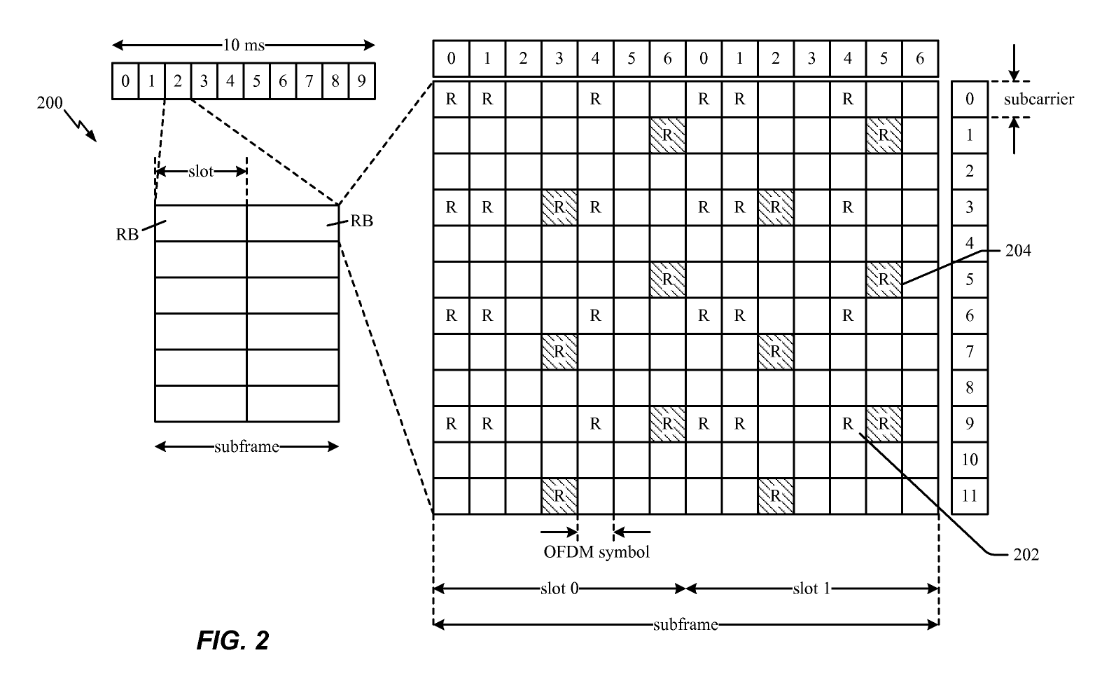

FIG. 2 is a diagram 200 illustrating an example of a downlink frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 202, 204, include downlink reference signals (DL-RS). The DL-RS include Cell-specific RS (CRS) (also sometimes called common RS) 202 and UE-specific RS (UE-RS) 204. UE-RS 204 are transmitted only on the resource blocks upon which the corresponding physical downlink shared channel (PDSCH) is mapped. The number of bits carried by each resource element depends on the modulation scheme. Thus, the more resource blocks that a UE receives and the higher the modulation scheme, the higher the data rate for the UE.

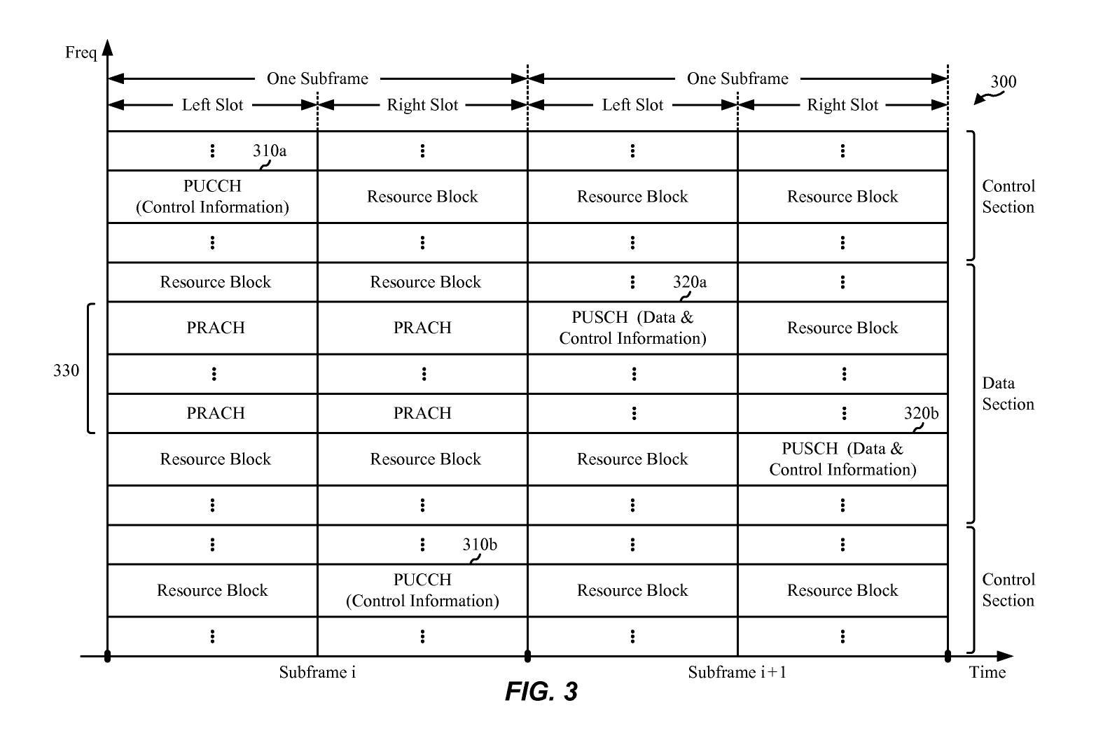

FIG. 3 is a diagram 300 illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 310a, 310b in the control section to transmit control information to an eNodeB. The UE may also be assigned resource blocks 320a, 320b in the data section to transmit data to the eNodeB. The UE may transmit control information in a physical uplink control channel (PUCCH) on the assigned resource blocks in the control section. The UE may transmit only data or both data and control information in a physical uplink shared channel (PUSCH) on the assigned resource blocks in the data section. An uplink transmission may span both slots of a subframe and may hop across frequency.

A set of resource blocks may be used to perform initial system access and achieve uplink synchronization in a physical random access channel (PRACH) 330. The PRACH 330 carries a random sequence and cannot carry any uplink data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

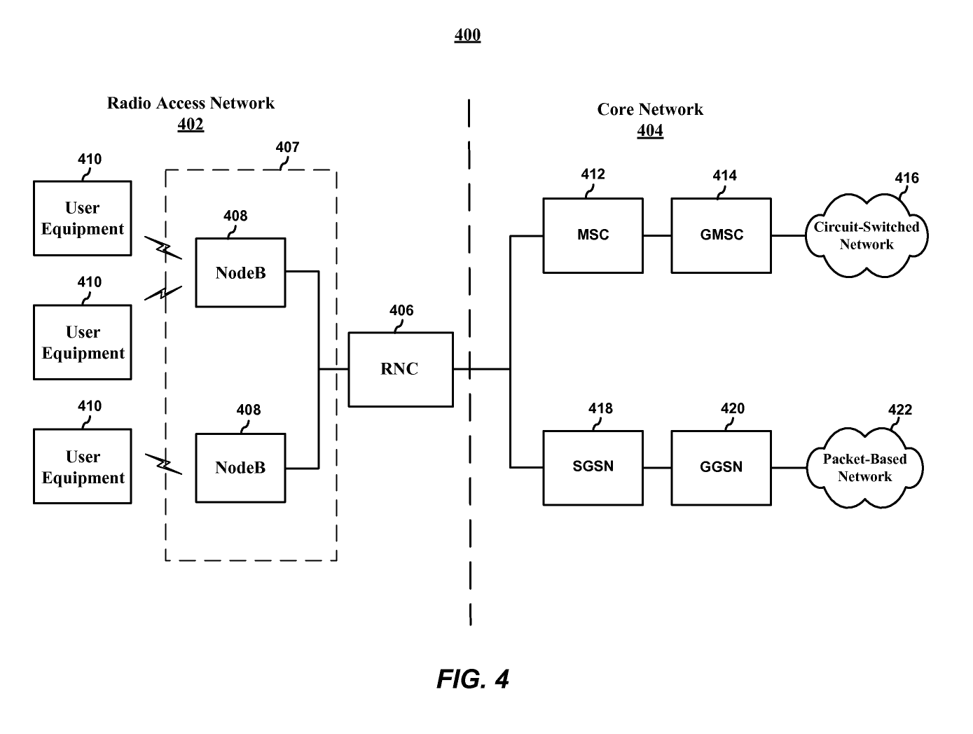

Turning now to FIG. 4, a block diagram is shown illustrating an example of a telecommunications system 400. The various concepts presented throughout this disclosure may be implemented across a broad variety of telecommunication systems, network architectures, and communication standards. By way of example and without limitation, the aspects of the present disclosure illustrated in FIG. 4 are presented with reference to a UMTS system employing a TD-SCDMA standard. In this example, the UMTS system includes a radio access network (RAN) 402 (e.g., UTRAN) that provides various wireless services including telephony, video, data, messaging, broadcasts, and/or other services. The RAN 402 may be divided into a number of radio network subsystems (RNSs) such as an RNS 407, each controlled by a radio network controller (RNC), such as an RNC 406. For clarity, only the RNC 406 and the RNS 407 are shown; however, the RAN 402 may include any number of RNCs and RNSs in addition to the RNC 406 and RNS 407. The RNC 406 is an apparatus responsible for, among other things, assigning, reconfiguring and releasing radio resources within the RNS 407. The RNC 406 may be interconnected to other RNCs (not shown) in the RAN 402 through various types of interfaces such as a direct physical connection, a virtual network, or the like, using any suitable transport network.

The geographic region covered by the RNS 407 may be divided into a number of cells, with a radio transceiver apparatus serving each cell. A radio transceiver apparatus is commonly referred to as a nodeB in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two nodeBs 408 are shown; however, the RNS 407 may include any number of wireless nodeBs. The nodeBs 408 provide wireless access points to a core network 404 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 410 are shown in communication with the nodeBs 408. The downlink (DL), also called the forward link, refers to the communication link from a nodeB to a UE, and the uplink (UL), also called the reverse link, refers to the communication link from a UE to a nodeB.

The core network 404, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 404 supports circuit-switched services with a mobile switching center (MSC) 412 and a gateway MSC (GMSC) 414. One or more RNCs, such as the RNC 406, may be connected to the MSC 412. The MSC 412 is an apparatus that controls call setup, call routing, and UE mobility functions. The MSC 412 also includes a visitor location register (VLR) (not shown) that contains subscriber-related information for the duration that a UE is in the coverage area of the MSC 412. The GMSC 414 provides a gateway through the MSC 412 for the UE to access a circuit-switched network 416. The GMSC 414 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 414 queries the HLR to determine the UE's location and forwards the call to the particular MSC serving that location.

The core network 404 also supports packet-data services with a serving GPRS support node (SGSN) 418 and a gateway GPRS support node (GGSN) 420. General packet radio service (GPRS) is designed to provide packet-data services at speeds higher than those available with standard GSM circuit-switched data services. The GGSN 420 provides a connection for the RAN 402 to a packet-based network 422. The packet-based network 422 may be the Internet, a private data network, or some other suitable packet-based network. The primary function of the GGSN 420 is to provide the UEs 410 with packet-based network connectivity. Data packets are transferred between the GGSN 420 and the UEs 410 through the SGSN 418, which performs primarily the same functions in the packet-based domain as the MSC 412 performs in the circuit-switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a nodeB 408 and a UE 410, but divides uplink and downlink transmissions into different time slots in the carrier.

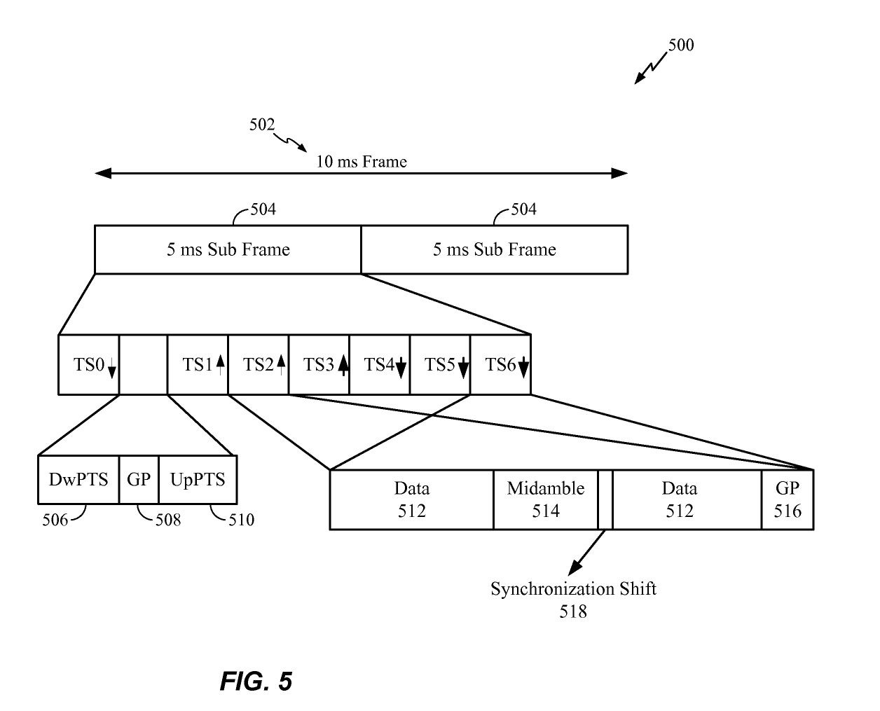

FIG. 5 shows a frame structure 500 for a TD-SCDMA carrier. The TD-SCDMA carrier, as illustrated, has a frame 502 that is 10 ms in length. The chip rate in TD-SCDMA is 1.28 Mcps. The frame 502 has two 5 ms subframes 504, and each of the subframes 504 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 506, a guard period (GP) 508, and an uplink pilot time slot (UpPTS) 510 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 512 (each with a length of 352 chips) separated by a midamble 514 (with a length of 144 chips) and followed by a guard period (GP) 516 (with a length of 16 chips). The midamble 514 may be used for features, such as channel estimation, while the guard period 516 may be used to avoid inter-burst interference. Also transmitted in the data portion is some Layer 1 control information, including synchronization shift (SS) bits 518. Synchronization Shift bits 518 only appear in the second part of the data portion. The synchronization shift bits 518 immediately following the midamble can indicate three cases: decrease shift, increase shift, or do nothing in the upload transmit timing. The positions of the synchronization shift bits 518 are not generally used during uplink communications.

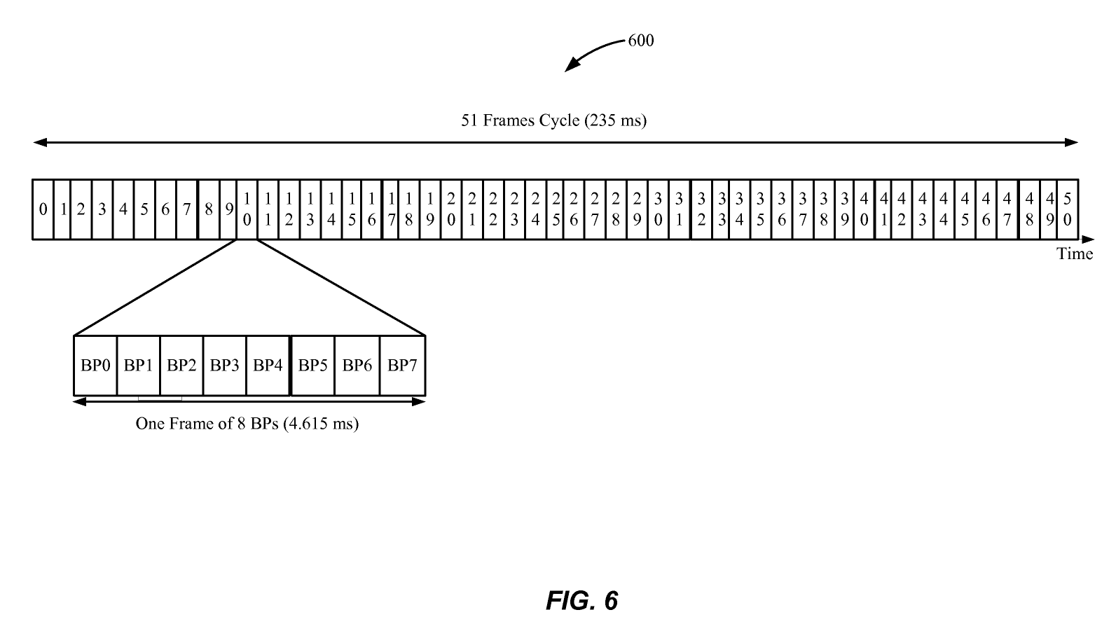

FIG. 6 is a block diagram illustrating an example of a GSM frame structure 600. The GSM frame structure 600 includes fifty-one frame cycles for a total duration of 235 ms. Each frame of the GSM frame structure 600 may have a frame length of 4.615 ms and may include eight burst periods, BP0-BP7.

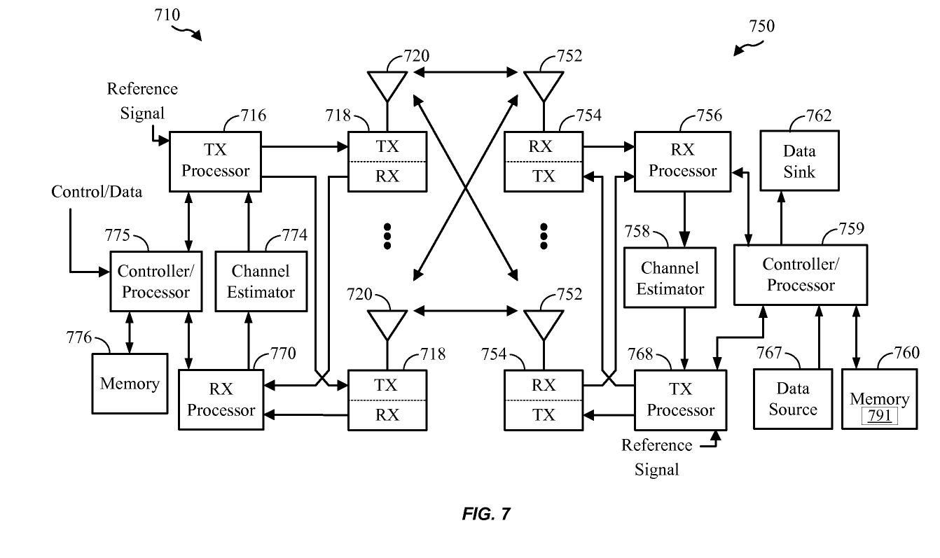

FIG. 7 is a block diagram of a base station (e.g., eNodeB or nodeB) 710 in communication with a UE 750 in an access network. In the downlink, upper layer packets from the core network are provided to a controller/processor 775. The controller/processor 775 implements the functionality of the L2 layer. In the downlink, the controller/processor 775 provides header compression, ciphering, packet segmentation and reordering, multiplexing between logical and transport channels, and radio resource allocations to the UE 750 based on various priority metrics. The controller/processor 775 is also responsible for HARQ operations, retransmission of lost packets, and signaling to the UE 750.

The TX processor 716 implements various signal processing functions for the L1 layer (i.e., physical layer). The signal processing functions includes coding and interleaving to facilitate forward error correction (FEC) at the UE 750 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 774 may be used to determine the coding and modulation scheme, as well as for spatial processing. The channel estimate may be derived from a reference signal and/or channel condition feedback transmitted by the UE 750. Each spatial stream is then provided to a different antenna 720 via a separate transmitter (TX) 718. Each transmitter (TX) 718 modulates a radio frequency (RF) carrier with a respective spatial stream for transmission.

At the UE 750, each receiver (RX) 754 receives a signal through its respective antenna 752. Each receiver (RX) 754 recovers information modulated onto an RF carrier and provides the information to the receiver (RX) processor 756. The RX processor 756 implements various signal processing functions of the L1 layer. The RX processor 756 performs spatial processing on the information to recover any spatial streams destined for the UE 750. If multiple spatial streams are destined for the UE 750, they may be combined by the RX processor 756 into a single OFDM symbol stream. The RX processor 756 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the base station 710. These soft decisions may be based on channel estimates computed by the channel estimator 758. The soft decisions are then decoded and deinterleaved to recover the data and control signals that were originally transmitted by the base station 710 on the physical channel. The data and control signals are then provided to the controller/processor 759.

The controller/processor 759 implements the L2 layer. The controller/processor can be associated with a memory 760 that stores program codes and data. The memory 760 may be referred to as a computer-readable medium. In the uplink, the controller/processor 759 provides demultiplexing between transport and logical channels, packet reassembly, deciphering, header decompression, control signal processing to recover upper layer packets from the core network. The upper layer packets are then provided to a data sink 762, which represents all the protocol layers above the L2 layer. Various control signals may also be provided to the data sink 762 for L3 processing. The controller/processor 759 is also responsible for error detection using an acknowledgement (ACK) and/or negative acknowledgement (NACK) protocol to support HARQ operations.

In the uplink, a data source 767 is used to provide upper layer packets to the controller/processor 759. The data source 767 represents all protocol layers above the L2 layer. Similar to the functionality described in connection with the downlink transmission by the base station 710, the controller/processor 759 implements the L2 layer for the user plane and the control plane by providing header compression, ciphering, packet segmentation and reordering, and multiplexing between logical and transport channels based on radio resource allocations by the base station 710. The controller/processor 759 is also responsible for HARQ operations, retransmission of lost packets, and signaling to the base station 710.

Channel estimates derived by a channel estimator 758 from a reference signal or feedback transmitted by the base station 710 may be used by the TX processor 768 to select the appropriate coding and modulation schemes, and to facilitate spatial processing. The spatial streams generated by the TX processor 768 are provided to different antenna 752 via separate transmitters (TX) 754. Each transmitter (TX) 754 modulates an RF carrier with a respective spatial stream for transmission.

The uplink transmission is processed at the base station 710 in a manner similar to that described in connection with the receiver function at the UE 750. Each receiver (RX) 718 receives a signal through its respective antenna 720. Each receiver (RX) 718 recovers information modulated onto an RF carrier and provides the information to a RX processor 770. The RX processor 770 may implement the L1 layer.

The controller/processor 775 implements the L2 layer. The controller/processors 775 and 759 can be associated with memories 776 and 760, respectively that store program codes and data. For example, the controller/processors 775 and 759 may provide various functions including timing, peripheral interfaces, voltage regulation, power management, and other control functions. The memories 776 and 760 may be referred to as a computer-readable media. For example, the memory 760 of the UE 750 may store a redirection module 791 which, when executed by the controller/processor 759, configures the UE 750 to perform fast return to a first RAT according to frequencies of the first RAT that are ranked based on a suspended application on the first RAT and characteristics of the frequencies.

In the uplink, the controller/processor 775 provides demultiplexing between transport and logical channels, packet reassembly, deciphering, header decompression, control signal processing to recover upper layer packets from the UE 750. Upper layer packets from the controller/processor 775 may be provided to the core network. The controller/processor 775 is also responsible for error detection using an ACK and/or NACK protocol to support HARQ operations.

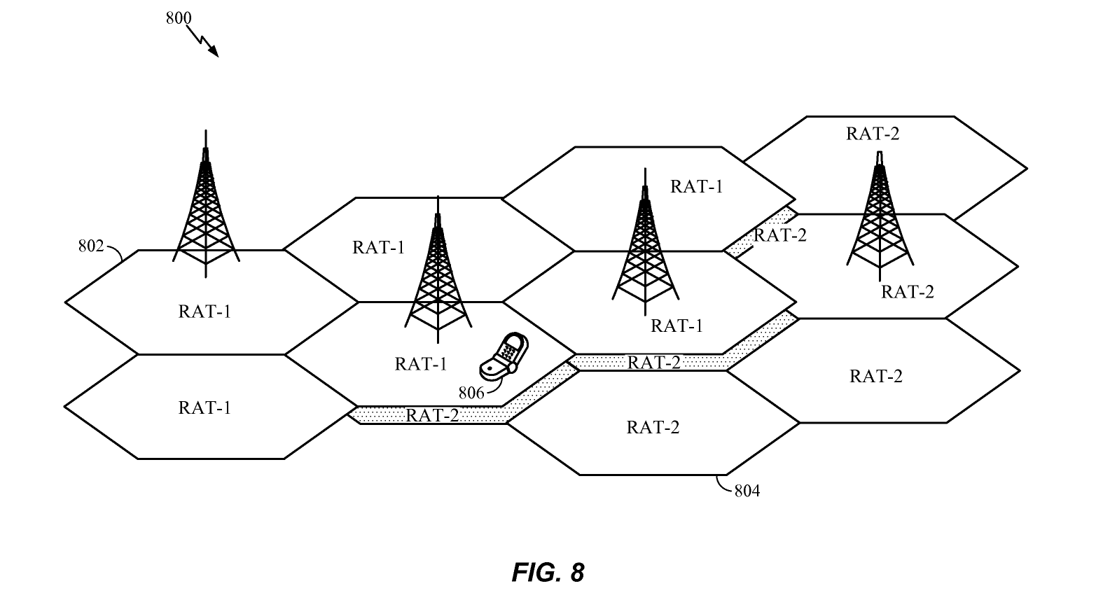

Some networks may be deployed with multiple radio access technologies. FIG. 8 illustrates a network utilizing multiple types of radio access technologies (RATs), such as but not limited to GSM (second generation (2G)), TD-SCDMA (third generation (3G)), LTE (fourth generation (4G)) and fifth generation (5G). Multiple RATs may be deployed in a network to increase capacity. Typically, 2G and 3G are configured with lower priority than 4G. Additionally, multiple frequencies within LTE (4G) may have equal or different priority configurations. Reselection rules are dependent upon defined RAT priorities. Different RATs are not configured with equal priority.

In one example, the geographical area 800 includes RAT-1 cells 802 and RAT-2 cells 804. In one example, the RAT-1 cells are 2G or 3G cells and the RAT-2 cells are LTE cells. However, those skilled in the art will appreciate that other types of radio access technologies may be utilized within the cells. A user equipment (UE) 806 may move from one cell, such as a RAT-1 cell 802, to another cell, such as a RAT-2 cell 804. The movement of the UE 806 may specify a handover or a cell reselection. The UE may also be redirected from a second RAT (RAT-2) to a different RAT (e.g., RAT-1) for a particular type of operation.

Redirection from one RAT to another RAT is commonly used to perform operations such as load balancing or circuit switched fallback from one RAT to another RAT. For example, one of the RATs may be long term evolution (LTE) while the other RAT may be universal mobile telecommunications system-frequency division duplexing (UMTS FDD), universal mobile telecommunications system-time division duplexing (UMTS TDD), or global system for mobile communications (GSM). In some aspects, the redirection may be from a frequency or cell of one RAT to a frequency or cell of the same RAT.

CSFB is a feature that enables multi-mode user equipment (UE) capable of communicating on a first RAT (e.g., LTE) in addition to communicating on a second RAT (e.g., 2G/3G) to obtain circuit switched voice services while being camped on the first RAT. For example, the CSFB capable UE may initiate a mobile-originated (MO) circuit switched voice call while on LTE. Because of the mobile-originated circuit switched voice call, the UE is redirected to a circuit switched capable RAT. For example, the UE is redirected to a radio access network (RAN), such as a 3G or 2G network, for the circuit switched voice call setup. In some instances, the CSFB capable UE may be paged for a mobile-terminated (MT) voice call while on LTE, which results in the UE being moved to 3G or 2G for the circuit switched voice call setup.

If there is a packet-switched (PS) call running in the LTE RAT when a circuit-switched voice call is triggered, the packet-switched call may be suspended. In addition, there may be one or more applications running on top of the packet-switched call. Upon completion of the circuit-switched voice call, a fast return to the LTE RAT is important. An expedited (or fast) return of the UE to the first RAT network (e.g., packet switched RAT such as LTE) after the completion of the circuit switched voice call is particularly important for high-speed data communications.

In some instances, the UE performs a blind or non-blind fast return to the LTE RAT upon receiving a radio resource control (RRC) release message from the circuit-switched network (e.g., 2G/3G network). The RRC release message includes redirection information such as LTE frequencies to help the UE return to the LTE network. Once the UE returns to the LTE network, the suspended packet-switched call is resumed.

When a circuit-switched call is released, however, the UE attempts a fast return to the strongest LTE frequency in the LTE acquisition history. The fast return attempt to the strongest LTE frequency occurs regardless of a call type of the suspended packet-switched call. In some instances, however, fast returning to the strongest LTE frequency is undesirable. For example, in the case where an undesirable frequency (e.g., public LTE frequency) has stronger coverage than a desirable frequency, (e.g., dedicated LTE frequency), the UE may return to the undesirable frequency. This may result in a high-speed state UE, (e.g., a UE traveling at a high speed), leaving the dedicated LTE frequency. For example, if the UE was previously on a first dedicated frequency (f1), after a circuit switched call, the UE may attempt to retune to f1. However, if the strength of f1 is too low (i.e., below a threshold), the UE may instead return to a different frequency (e.g., f2, f3), which may not be desirable.

### Fast Return Based on Frequencies Ranked According to Suspended Application and Frequency Characteristics

Aspects of the present disclosure are directed to a fast return implementation where a user equipment (UE) returns to a desirable frequency of a first radio access technology (e.g., serving RAT) when a circuit-switched call on a second RAT is released. In some implementations, the first RAT includes a long term evolution (LTE) RAT. The second RAT may be a second/third (2G/3G) RAT. In one aspect of the disclosure, the UE periodically suspends communications on the first RAT to redirect another communication or initiate the other communication on the second RAT. For example, the UE suspends an application running on the first RAT before switching to the second RAT.

Prior to returning to the first RAT from the second RAT, the UE ranks frequencies in an acquisition history. The acquisition history may include a record of frequencies (e.g., LTE frequencies and/or frequencies of other RATs) in a list to facilitate future use of the frequencies by the UE. In addition to recording frequencies in the acquisition history, the UE can also record characteristics of each frequency of the first RAT in the acquisition history. For example, the recorded characteristics include a frequency bandwidth, a frequency type (e.g., LTE frequency division duplex (FDD) frequency or a time division duplex (TDD) frequency), a frequency service capability (e.g., frequency supports packet-switched (PS) communications only such as voice over LTE (VoLTE), PS and circuit-switched (CS) communications), an uplink and downlink sub-frame configuration (e.g., for LTE TDD frequency), whether carrier aggregation is available, whether carrier aggregation with WLAN is available, and other frequency characteristics for each frequency recorded. The frequency type may also include high band, middle band, low band, and/or licensed or unlicensed frequency.

In one aspect of the disclosure, the ranking of the frequencies may be based on a type of the suspended application in the first RAT, and the characteristics of each frequency in the acquisition history. Accordingly, the UE may search and select a desirable frequency upon return from the redirection based on the type of the suspended application in the first RAT, and the characteristics. For example, when the circuit-switched call is released, instead of attempting a fast return to the strongest frequency, the UE may select a desirable frequency according to the ranked information in the acquisition history.

Some types of applications of the suspended application include a transmission pattern, reception pattern and a quality of service (QoS) specification. The transmission pattern and/or the reception pattern include bandwidth specification or requirement, and a proportion of downlink transmissions with respect to uplink transmissions. The transmission pattern may include an increase in downlink (DL) usage, an increase in uplink (UL) usage or symmetric UL/DL usage. Other frequency characteristics for the selection include a carrier aggregation (CA) capability and a wireless local area network (WLAN) support for carrier aggregation. For example, the selection of the frequency may be based on whether a frequency supports carrier aggregation with a wireless local area network.

In one aspect of the disclosure, the UE determines whether a suitable cell corresponding to the selected frequency (e.g., higher ranked frequency) is present. For example, a suitable cell has a signal quality above a predetermined or network indicated threshold. When a suitable cell is detected based on the selected frequency, the UE returns to the selected, desirable frequency instead of the strongest LTE frequency. Otherwise, when the suitable cell is not detected for at least one higher ranked frequency, the UE searches at least one next frequency according to the ranking.

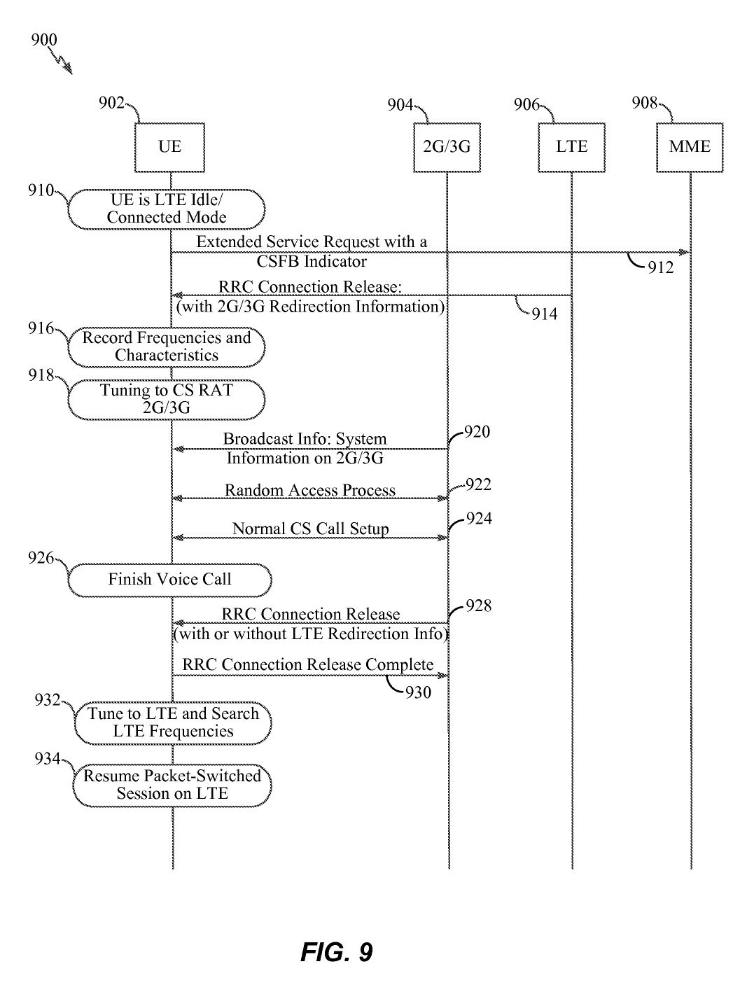

FIG. 9 shows a flow diagram 900 conceptually illustrating an example process for fast return to a desirable frequency after redirection according to one aspect of the present disclosure. The UE 902 at time 910 may be camped on a first RAT (e.g., LTE or 5G) network. Then, the UE 902 may originate or receive a voice call and a redirection service may be invoked to service the voice call.

The redirection service is to redirect the UE 902 from the first RAT to a second RAT (e.g., 2G/3G) for a particular service. As noted, the service may include load balancing, circuit-switched fallback (CSFB), and others. For example, the UE 902 may be a multimode, CSFB-capable UE supporting 2G/3G with LTE capabilities and may use the CSFB feature for circuit switched (CS) voice services while being camped on an LTE network 906. The UE 902 may initiate a mobile-originated (MO) circuit switched (CS) voice call while on the LTE network 906, which results in the UE 902 being redirected to a CS capable 2G/3G network 904. Alternatively, the UE 902 may be paged for a mobile-terminated (MT) voice call while camped on the LTE network 906, which also results in the UE 902 being redirected to the 2G/3G network 904 for CS voice call setup.

In order to perform a particular function, for example to place or receive a voice call, the UE 902, at time 912, sends an extended service request (ESR) to a mobility management entity (MME) 908 to initiate a redirection for a CSFB service. A CSFB indicator is included in the ESR message. For example, the CSFB indicator may be included to initiate a disconnection of the UE 902 from the LTE network 906 (serving RAT).

At time 914, the LTE network 906 sends a radio resource connection (RRC) connection release message with 2G/3G redirection information to initiate a redirection to the CSFB-capable 2G/3G network 904. The LTE network 906 may also send the UE 902 a list of frequencies (e.g., LTE frequencies). The UE 902 identifies characteristics of each frequency on the list of frequencies. The characteristics may be determined by the UE 902 and/or the LTE network 906. The UE 902 may also identify the suspended application running on the first RAT before being redirected to the second RAT. The UE 902 may record the list of frequencies and their corresponding characteristics in memory (e.g., buffer) for future use, as shown at time 916. The frequencies and their corresponding characteristics may be recorded as an acquisition history. In one aspect of the disclosure, the frequencies are ranked in the acquisition history based on the type of the suspended application, and the characteristics of each frequency in the acquisition history.

At time 918, as part of redirection to the 2G/3G network 904, the UE 902 tunes to a 2G/3G RAT to acquire information about the 2G/3G network 904. For example, the UE 902 tunes to the target RAT (2G/3G network) 904 indicated in the RRC connection release message. At time 920, the 2G/3G network 904 broadcasts its system information on a 2G/3G RAT broadcast channel.

At time 922, after receiving the system information, the UE 902 and the 2G/3G network 904 may enter a random access process to establish a connection between the UE 902 and the 2G/3G network 904. At time 924, the UE 902 and the 2G/3G network 904 go through a normal call setup procedure to enable voice call service. At time 926, the UE 902 finishes the voice call.

At time 928, the 2G/3G network 904 sends an RRC connection release message as part of the process to tear down the established connection. The release message may include LTE redirection information to help the UE 902 return to the LTE network 906. At time 930, the UE 902 sends an RRC connection release complete message to complete the connection tear down process.

After the circuit switched call is released, a fast return by the UE 902 to the LTE network 906 is desired. For example, at time 932, the UE 902 tunes to the LTE network 906 and searches the frequencies based on the ranking of frequencies stored in the UE buffer. The rank indicated in the stored memory dictates which frequencies to search first. If the high ranked frequencies are not located, then lower ranked frequencies from the acquisition history are searched.

As discussed above, the frequency ranking is based on a type of suspended application and characteristics of each frequency. Some types for the suspended applications include a transmission pattern, reception pattern and a quality of service specification. The transmission pattern and/or the reception pattern include bandwidth specification, and a proportion of downlink transmissions with respect to uplink transmissions. The transmission pattern may include an increase in downlink (DL) usage, an increase in uplink (UL) usage or symmetric UL/DL usage. Other frequency characteristics for the selection include carrier aggregation (CA) capability and wireless local area network (WLAN) support for carrier aggregation. For example, the selection of the frequency may be based on whether a frequency supports carrier aggregation with a wireless local area network.

When the UE 902 detects a desirable cell of a frequency selected based on the rank indicated in memory, the UE 902 returns to the detected cell and resumes the suspended application (e.g., packet switched communication) on the LTE network 906, at time 934.

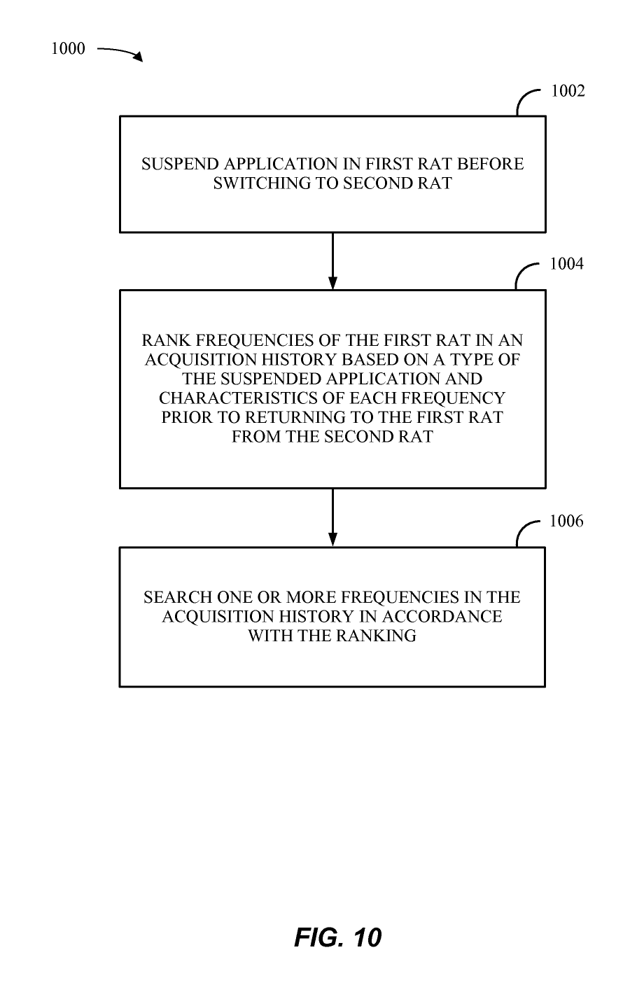

FIG. 10 is a flow diagram illustrating a method 1000 for fast return according to aspects of the present disclosure. At block 1002, the UE suspends an application in a first radio access technology (RAT) before switching to a second RAT. The UE then ranks frequencies of the first RAT in an acquisition history prior to returning to the first RAT from the second RAT, as shown at block 1004. The rank of the frequencies may be based on a type of a suspended application in the first RAT, and characteristics of each frequency in the acquisition history. At block 1006, the UE searches one or more frequencies in the acquisition history in accordance with the ranking.

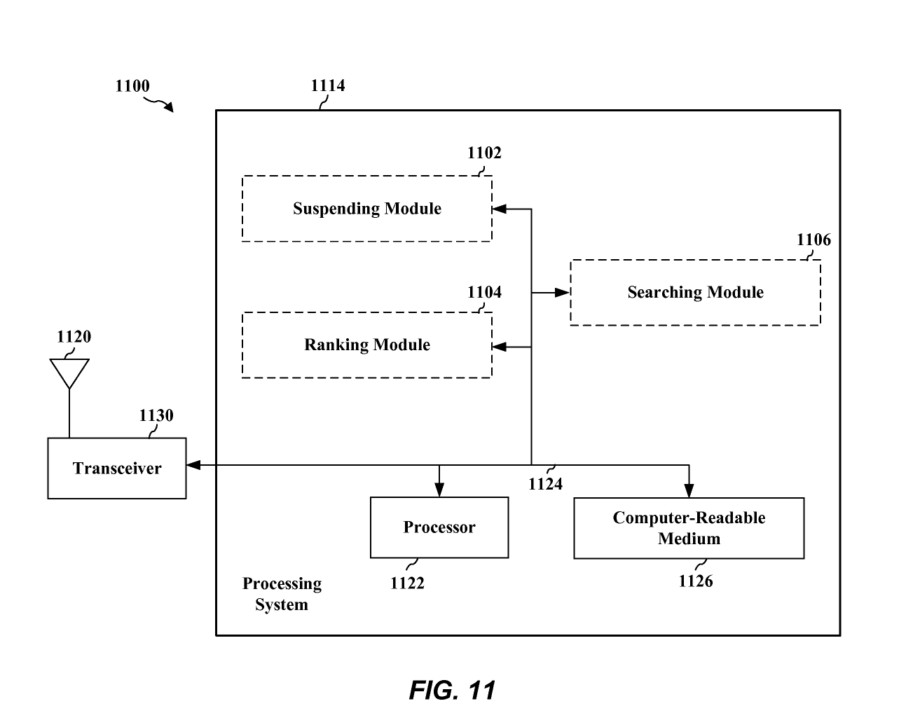

FIG. 11 is a block diagram illustrating an example of a hardware implementation for an apparatus 1100 employing a processing system 1114 with different modules/means/components for fast return failure handling in a high-speed scenario in an example apparatus according to one aspect of the present disclosure. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware modules, represented by the processor 1122 the modules 1102, 1104, 1106 and the non-transitory computer-readable medium 1126. The bus 1124 may also link various other circuits such as timing sources, peripherals, voltage regulators, and power management circuits, which are well known in the art, and therefore, will not be described any further.

The apparatus includes a processing system 1114 coupled to a transceiver 1130. The transceiver 1130 is coupled to one or more antennas 1120. The transceiver 1130 enables communicating with various other apparatus over a transmission medium. The processing system 1114 includes a processor 1122 coupled to a non-transitory computer-readable medium 1126. The processor 1122 is responsible for general processing, including the execution of software stored on the computer-readable medium 1126. The software, when executed by the processor 1122, causes the processing system 1114 to perform the various functions described for any particular apparatus. The computer-readable medium 1126 may also be used for storing data that is manipulated by the processor 1122 when executing software.

The processing system 1114 includes a suspending module 1102 for suspending an application in a first radio access technology (RAT) before switching to a second RAT. The processing system 1114 also includes a ranking module 1104 for ranking frequencies of the first RAT in an acquisition history prior to returning to the first RAT from the second RAT. The processing system 1114 may also include a searching module 1106 for searching one or more frequencies in the acquisition history in accordance with the ranking. The modules 1102, 1104 and 1106 may be software modules running in the processor 1122, resident/stored in the computer-readable medium 1126, one or more hardware modules coupled to the processor 1122, or some combination thereof. The processing system 1114 may be a component of the UE 750 of FIG. 7 and may include the memory 760, and/or the controller/processor 759.

In one configuration, an apparatus such as a UE 750 is configured for wireless communication including means for suspending an application in a first radio access technology (RAT) before switching to a second RAT. In one aspect, the suspending means may be the receive processor 756, the controller/processor 759, the memory 760, suspending module 1102, and/or the processing system 1114 configured to perform the functions recited by the suspending means. In one configuration, the means functions correspond to the aforementioned structures. In another aspect, the aforementioned means may be a module or any apparatus configured to perform the functions recited by the aforementioned means.

The UE 350 is also configured to include means for ranking frequencies of the first RAT in an acquisition history based at least in part on a type of a suspended application in the first RAT, and characteristics of each frequency in the acquisition history. In one aspect, the ranking means may include the antennas 752, receive processor 756, the controller/processor 759, the memory 760, the ranking module 1104, and/or the processing system 1114 configured to perform the functions recited by the ranking means. In one configuration, the means and functions correspond to the aforementioned structures. In another aspect, the aforementioned means may be a module or any apparatus configured to perform the functions recited by the suspending means.

The UE 350 is also configured to include means for searching one or more frequencies in the acquisition history in accordance with the ranking. In one aspect, the searching means may include the antennas 752, the receiver 754, the receive processor 756, the controller/processor 759, the memory 760, the searching module 1106, and/or the processing system 1114 configured to perform the functions recited by the searching means. The UE 350 may further be configured such that the searching means includes means for determining whether a suitable cell corresponds to at least one higher ranked frequency is present, and also means for searching at least one next frequency according to the ranking when the suitable cell is not detected for the at least one higher ranked frequency. In one configuration, the means and functions correspond to the aforementioned structures. In another aspect, the aforementioned means may be a module or any apparatus configured to perform the functions recited by the searching means.

The UE 350 may also be configured to include a means for recording characteristics of each frequency of the first RAT into the acquisition history. In one aspect, the recording means may the controller/processor 759, and/or the processing system 1114 configured to perform the functions recited by the recording. In one configuration, the means and functions correspond to the aforementioned structures. In another aspect, the aforementioned means may be a module or any apparatus configured to perform the functions recited by the suspending means.

Several aspects of a telecommunications system has been presented with reference to LTE, TD-SCDMA, 5G (fifth generation) and GSM systems. As those skilled in the art will readily appreciate, various aspects described throughout this disclosure may be extended to other telecommunication systems, network architectures and communication standards, including those with high throughput and low latency such as 4G systems, 5G systems and beyond. By way of example, various aspects may be extended to other systems such as or LTE-advanced (LTE-A), W-CDMA, high speed downlink packet access (HSDPA), high-speed uplink packet access (HSUPA), high speed packet access plus (HSPA+) and TD-CDMA. Various aspects may also be extended to systems employing ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

It is also to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication for a multi-mode user equipment (UE), comprising:
suspending an application in a first RAT (radio access technology) before switching to a second RAT;
prior to returning from a second RAT to the first RAT, ranking frequencies of the first RAT in an acquisition history based at least in part on a type of a suspended application in the first RAT, and characteristics of each frequency in the acquisition history; and
searching at least one frequency in the acquisition history in accordance with the ranking.

2. The method of claim 1, in which the searching comprises:
determining whether a suitable cell corresponding to at least one higher ranked frequency is present; and
searching at least one next frequency according to the ranking when the suitable cell is not detected for the at least one higher ranked frequency.

3. The method of claim 1, further comprising recording the characteristics of each frequency of the first RAT into the acquisition history.

4. The method of claim 1, in which the characteristics comprise an uplink and downlink subframe configuration, a frequency bandwidth, a frequency service capability, the frequency type, a carrier aggregation (CA) capability, and whether the frequency supports carrier aggregation with a wireless local area network (WLAN).

5. The method of claim 1, in which the type of the suspended application comprises a transmission pattern, reception pattern and a quality of service (QoS) specification.

6. The method of claim 5, in which the transmission pattern and reception pattern comprise bandwidth specification, and a proportion of downlink transmissions with respect to uplink transmissions.

7. An apparatus for wireless communication for a multi-mode user equipment (UE), comprising:
means for suspending an application in a first RAT (radio access technology) before switching to a second RAT;
means for ranking frequencies of the first RAT, prior to returning from the second RAT to the first RAT, in an acquisition history based at least in part on a type of a suspended application in the first RAT, and characteristics of each frequency in the acquisition history; and
means for searching at least one frequency in the acquisition history in accordance with the ranking.

8. The apparatus of claim 7, in which the searching means comprises:
means for determining whether a suitable cell corresponding to at least one higher ranked frequency is present; and
means for searching at least one next frequency according to the ranking when the suitable cell is not detected for the at least one higher ranked frequency.

9. The apparatus of claim 7, further comprising means for recording characteristics of each frequency of the first RAT into the acquisition history.

10. The apparatus of claim 7, in which the characteristics comprise an uplink and downlink subframe configuration, a frequency bandwidth, a frequency service capability, the frequency type, a carrier aggregation (CA) capability, and whether the frequency supports carrier aggregation with a wireless local area network (WLAN).

11. The apparatus of claim 7, in which the type of the suspended application comprises a transmission pattern, reception pattern and a quality of service (QoS) specification.

12. The apparatus of claim 11, in which the transmission pattern and reception pattern comprise bandwidth specification, and a proportion of downlink transmissions with respect to uplink transmissions.

13. An apparatus for wireless communication for a multi-mode user equipment (UE), comprising:
a memory; and
at least one processor coupled to the memory and configured:
to suspend an application in a first RAT (radio access technology) before switching to a second RAT;
to rank frequencies of the first RAT, prior to returning from the second RAT to the first RAT, in an acquisition history based at least in part on a type of a suspended application in the first RAT, and characteristics of each frequency in the acquisition history; and
to search at least one frequency in the acquisition history in accordance with the ranking.

14. The apparatus of claim 13, in which the at least one processor is configured to search by:
determining whether a suitable cell corresponding to at least one higher ranked frequency is present; and
searching at least one next frequency according to the ranking when the suitable cell is not detected for the at least one higher ranked frequency.

15. The apparatus of claim 13, in which the at least one processor is further configured to record the characteristics of each frequency of the first RAT into the acquisition history.

16. The apparatus of claim 13, in which the characteristics comprise an uplink and downlink subframe configuration, a frequency bandwidth, a frequency service capability, the frequency type, a carrier aggregation (CA) capability, and whether the frequency supports carrier aggregation with a wireless local area network (WLAN).

17. The apparatus of claim 13, in which the type of the suspended application comprises a transmission pattern, reception pattern and a quality of service (QoS) specification.

18. The apparatus of claim 17, in which the transmission pattern and reception pattern comprise bandwidth specification, and a proportion of downlink transmissions with respect to uplink transmissions.

19. A computer program product for wireless communication for a multi-mode user equipment (UE), comprising:
a non-transitory computer-readable medium having program code recorded thereon, the program code comprising:
program code to suspend an application in a first RAT (radio access technology) before switching to a second RAT;
program code to rank frequencies of the first RAT, prior to returning from the second RAT to the first RAT, in an acquisition history based at least in part on a type of a suspended application in the first RAT, and characteristics of each frequency in the acquisition history; and
program code to search at least one frequency in the acquisition history in accordance with the ranking.

20. The computer program product of claim 19, in which the program code to search further comprises:
program code to determine whether a suitable cell corresponding to at least one higher ranked frequency is present; and
program code to search at least one next frequency according to the ranking when the suitable cell is not detected for the at least one higher ranked frequency.

21. The computer program product of claim 19, further comprising program code to record the characteristics of each frequency of the first RAT into the acquisition history.

22. The computer program product of claim 19, in which the characteristics comprise an uplink and downlink subframe configuration, a frequency bandwidth, a frequency service capability, the frequency type, a carrier aggregation (CA) capability, and whether the frequency supports carrier aggregation with a wireless local area network (WLAN).

23. The computer program product of claim 19, in which the type of the suspended application comprises a transmission pattern, reception pattern and a quality of service (QoS) specification.

24. The computer program product of claim 23, in which the transmission pattern and reception pattern comprise bandwidth specification, and a proportion of downlink transmissions with respect to uplink transmissions.
